(19) United States
(12) Patent Application Publication
(10) Pub. No.: US 2008/0007212 A1
(43) Pub. Date: Jan. 10, 2008

(54) Universal charger

(75) Inventors: Olivier Theytaz, Savigny (CH); Stephane Delorenzi, Lausanne / VD (CH); Alain Tabasso, Essertines (CH); Patrick Monney, Mex (CH); Olivier Schaer, Prevonloup (CH); Daniel Bonanno, Geneve (CH); Alexis Richard, Cully (CH); Sergio Lazzarotto, Bercher (CH); Pascal Eichenberger, Blonay / VD (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/482,181

(22) Filed: Jul. 5, 2006

(51) Int. Cl. H02J 7/00

(52) U.S. Cl. 320/107

(57) ABSTRACT

A universal charger which can charge multiple electronic devices, such as a keyboard, mouse, remote control, etc. In one embodiment, a user is directed to a website over the internet to a site containing charging profiles for multiple devices. The user selects the particular devices the user will want to charge and downloads the charging profiles. The charging profiles are provided to the universal charger device. A number of mechanisms are provided to identify the device, such as wireless or wired communication with the device or reading an RFID tag in the device. Various embodiments are disclosed, including having smaller devices (remote control, mouse) moved to the charger and the charger move to larger devices (keyboard). Also, various indicators are shown to indicate which device needs charging, and various lighting schemes show the amount of charging.

### BACKGROUND OF THE INVENTION

The present invention relates to a charger which can charge multiple computer and electronics peripheral devices, and in particular a keyboard, mouse and remote control.

U.S. Pat. No. 4,006,396, issued in 1977, shows a universal charger for multiple types of batteries, with circuits for different charging rates. U.S. Pat. No. 5,828,966, issued in 1998, claims a reconfigurable cradle with interchangeable supports to charge different types of mobile phones which may have two or three connectors, and which may have the connectors at the top, bottom or sides. Duracell's 1997 U.S. Pat. No. 5,828,966 describes a universal charger with multiple male tabs for engaging a different number of female slots on different batteries. Palm, Inc.'s 2003 U.S. Pat. No. 6,614,206 describes a charger with multiple USB connections for providing charge to multiple devices.

U.S. Pat. No. 6,894,457 is directed to a charger with multiple cords for charging multiple portable devices. U.S. Pat. No. 5,157,319 shows an induction charger with a magnetic core surrounding the induction coil.

Gomadic's new Universal USB Travel Charger Adapter with Power Surge Protection has a plug which fits any standard AC wall outlet, and a USB port for providing power to a PDA. The USB end of a Power Sync cable is plugged into the integrated USB socket and the adapter is plugged into a standard AC wall outlet.

A Universal USB Charger Kit For Cell Phones from CellPhoneShop.net plugs into a cigarette lighter of a car, and provides a USB connector for providing power. It also provides Motorola, Nextel, Nokia, Samsung, Sony Ericsson cell phone jack connectors. It allows charging a phone through any USB-powered port, with a 5 volt output.

Different devices to be charged use different charging profiles. The charging profile indicates the rate at which charges apply to the device in the form of current per unit of time, as well as the voltage at which the charge is applied. Some devices, such as cordless phones, portable CD players and similar consumer goods, use a slow charger, while other devices, such as cell phones, laptops, and camcorders, use a quick charger. For many devices, it is important to detect when the device is fully charged, so that the battery is not overcharged, thereby causing damage to the battery. In some chargers, the temperature of the battery can be detected as well as the charge on it to adjust the charging current provided. Typically, dedicated chargers for various devices are designed to provide the current profile needed by that particular device.

### BRIEF SUMMARY OF THE INVENTION

The present invention provides a universal charger which can charge multiple electronic devices, such as a keyboard, mouse, remote control, etc. In one embodiment, a user is directed to a website over the internet to a site containing charging profiles for multiple devices. The user selects the particular devices the user will want to charge and downloads the charging profiles. The charging profiles are provided to the universal charger device.

In one embodiment, when a particular device is positioned to be charged by the charger, there is a communication between the charger and the device to determine the identity of the device in order to select the appropriate charging profile. In one embodiment, this is done through a USB connection. In another embodiment, this is done through a wireless connection. Alternately, a particular adaptor for that device can be used, with the connection of the adaptor indicating the type of device to be charged and thus selecting the appropriate charging profile.

In one embodiment, the universal charger can be used as a stand alone device once the profiles of associated devices (e.g., cell phone, PDA, camera) have been downloaded via access to a database through a PC. In this embodiment, the universal charger includes a display and keys to manually select the device the user wants to charge. The display also serves to indicate the charging status. The universal charger is compatible with all types of AC plugs worldwide. The connectors from the universal charger to devices (basically one per device) can be either specific (order on the web site where profile are downloaded) or generic (general jack plugs, etc.)

In one embodiment, the universal charger is designed so that smaller devices (remote control, mouse) can be moved to the charger and connected with it or be in close proximity for wireless charging. For a larger device (keyboard), the universal charger is designed to move to the larger device for charging. The charger in one embodiment has a low profile so that it can slide under a keyboard or so that a mouse or remote control or other device can slide over it. In another embodiment, the charge includes a ribbon cable for connecting to the different devices. In one embodiment, the charger has a bump or other protrusion for locating the device over the charger in the correct position. In another embodiment, the charger has a concave opening that is spring-loaded, so that a device can slide into the concave gap of the charger for connection. In one embodiment, the charger has a first set of connectors for devices it moves to (e.g., keyboard) and another set of connectors for devices which mount on it (e.g., mouse, remote control, cell phone, PDA).

In one embodiment, the present invention provides a flash capacitor or power cell which can be moved from the charger and inserted into the device in order to quickly recharge the batteries of the device.

In one embodiment, the charger includes an articulated arm, similar to those for supporting a desk lamp, which can be moved over to connect with a keyboard or other large device for charging.

In one embodiment, the charger provides a visual indication of the amount of charging, such as by having a lighted display on both the charger and the device, with the display appearing to run together when the two are connected. The displays light up, with light extending from the charger onto the device itself so that light is seen as moving from the charger to the device.

In one embodiment, the charger is in communication with the devices over a USB or wireless port, and provides a visual indication of when a charge is required. The visual indication can be either a display on the charger identifying the device or a color LED lighting up which corresponds to a color LED on the device itself. Different devices would have different color LEDs. Alternately, a mechanical indication of the need for a charge, such as the connector interface to the charger popping open, may be provided. Additionally, on completion of charge, a similar visual signal may be sent, or the charger may automatically mechanically disconnect.

In one embodiment, the charger plugs into wall power to provide power to the devices. In another embodiment, the charger is a fuel cell which does not need to be plugged in to recharge the devices. For example, such as fuel cell could provide a small number of charges to a device on a business trip without needing to be plugged in.

The charging profile to be applied to the device can be determined by communication with a device in any number of ways. In one embodiment, the type of device is identified by the particular adaptor that is plugged into the charger. In another embodiment, a USB connection provides a communication channel for identifying the device. In another embodiment, the device is RFID/NFC compatible. An advantage of using an RFID chip in the device is that power is not required for the charger to recognize the device.

### BRIEF DESCRIPTION OF THE DRAWINGS

FIG. 1 is a diagram of a system according to an embodiment of the invention with a charger having charging characteristics downloaded from a remote database.

FIGS. 2A-2D illustrate a low profile charger according to one embodiment of the invention where small devices move to it and it moves to large devices.

FIG. 3 is a diagram of an embodiment of a charger with a ribbon cable.

FIG. 4 is a diagram of a ribbon cable being pulled back into a charger according to an embodiment of the invention.

FIG. 5 is a diagram of a low profile charger with a bump for locating a device properly on it according to an embodiment of the invention.

FIG. 6 is a diagram of an embodiment of the invention showing a mouse mounted over a low profile charger.

FIG. 7 is a diagram of a charger having a slot for engaging a tab in a device for making a charging connection according to an embodiment of the invention.

FIGS. 8A-8C are diagrams of an embodiment of a charger having a cavity for receiving a device to be charged and being spring biased to clamp onto the device.

FIGS. 9A-9D illustrate an embodiment of the invention where small devices mount on the universal charge and large devices have the charger slide under it.

FIG. 10 is a diagram of an embodiment of the invention using a removable flash capacitor or power cell.

FIG. 11 is a diagram of an embodiment of the invention showing an articulating arm for connecting between a charger and a device.

FIG. 12 is a diagram of an embodiment of the invention with the charger having multiple colored lights matching different colored lights on different devices for indicating which device needs charging.

FIG. 13 is a diagram of an embodiment of a charger having a connection which pops open to indicate that it is time to charge a device.

FIG. 14 is a diagram of an embodiment of the invention showing adjacent light displays on both the charger and the device for indicating the flow of charge to the device.

FIG. 15 is a diagram of an embodiment of the invention showing a curved light display for indicating visually charge flowing from the charger to a device.

FIG. 16 is a diagram of a fuel cell system for charging a device according to an embodiment of the invention.

### DETAILED DESCRIPTION OF THE INVENTION

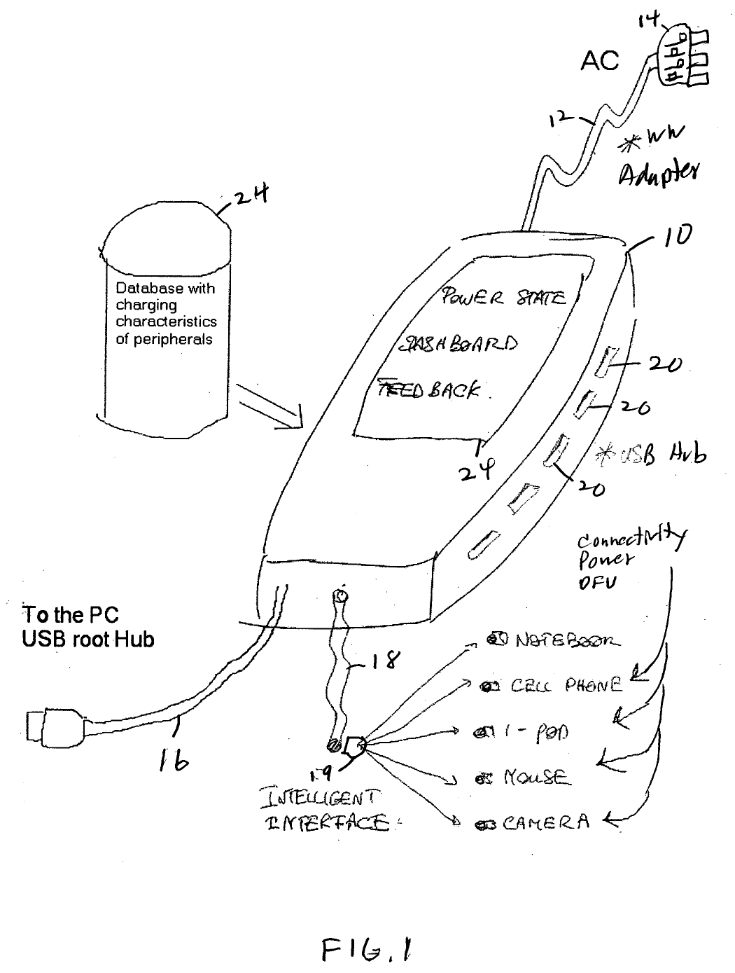

FIG. 1 illustrates a universal charger 10 connected by a cable 12 and adaptor 14 to AC power. Charger 10 includes a USB cable 16 for connecting to a PC USB port or a root hub. A cable 18 connects to various electronic devices, such as a notebook computer, cell phone, iPod, PDA, mouse, camera, etc. A single universal cable could be used, or separate cables could be plugged in, or customized adaptors could be applied to a single universal cable. The universal cable is a USB cable in one embodiment. The charger also includes a number of USB connectors 20 which are connected to an internal USB hub.

A data storage device 20 at a remote site stores charging characteristics of different devices to be connected to the charger. The user, upon installing the charger, can access the website where database 20 is located, using any number of means. This can be through a display 24 on the charger, with soft keys provided, or it could be done using the personal computer. A browser on the computer can access the website and allow the user to select the particular brands and types of devices which are going to be connected the universal charger. Alternately, the computer can automatically supply or supplement this list by detecting which devices are connected to it. The charging characteristics, including the charging profiles, of those devices are then downloaded to the PC. The PC communicates with the charger either over USB cable 16 or wirelessly to provide the charging characteristics to a memory or configuration logic of charger 10. Alternately, the data can be stored in the PC with charger 10 having access to the PC data through the USB or wireless connection.

When a particular device, such as a cell phone, is subsequently connected to charger 10, it is identified and the appropriate charging profile is pulled up and used to control the charge provided to the device. The particular device can be identified in any number of manners. A particular adaptor 19 might identify itself to the charger 10 in order to identify the type of device the adaptor is designed for. In one embodiment, the adaptor could have a resistor value, which is read, or a digital code stored in a chip which can be read, in order to inform charger 10 of the type of adaptor that it is. Alternately, charger 10 or the PC could communicate directly with the device either wirelessly, through a USB connection, or by reading an RFID chip in the device to determine its identity.

In one embodiment, when a new device is connected to the personal computer, information about the device is sent to the charger. The device may be interrogated by the computer or charger, and provide charging profile information. Alternately, the remote website is automatically contacted to download the charging provide, with or without user intervention.

In one embodiment, the charger performs dual functions as a universal charger and a USB port replicator or hub. The charger can itself can be powered either using the AC cord or can be powered through the USB cable.

In one embodiment, display 24 can indicate, via a power meter display, the amount of charge available or remaining for recharging. The display could also include a user input through a soft key or an associated button for a user to indicate the type of device being connected, rather than the charger automatically determining the type of device through the methods described above.

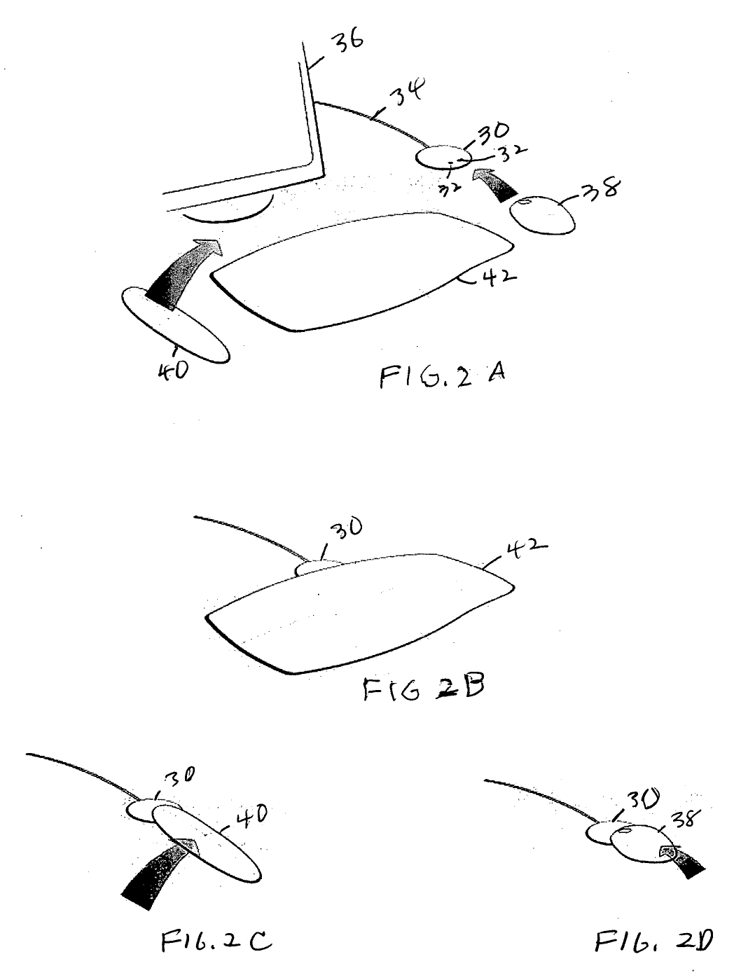

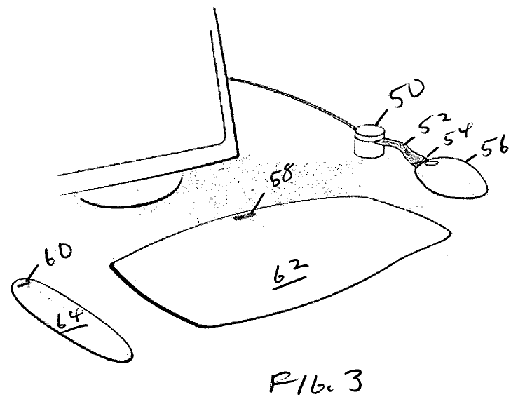

FIGS. 2A-2D illustrate an embodiment of a system with a low profile universal charger 30 having contacts 32 for making a direct connection with a device to be charged. In the example shown, the charger is connected via cable 34 either to a PC 36 or to AC power or both.

Small devices, such as a mouse 38 and a remote control 40, can be moved to connect to charger 30 as illustrated in FIGS. 2C and 2D. A larger device, such as a keyboard 42, is more unwieldy to move, and accordingly the charger 30 moves to the keyboard 42 as illustrated in FIG. 2B.

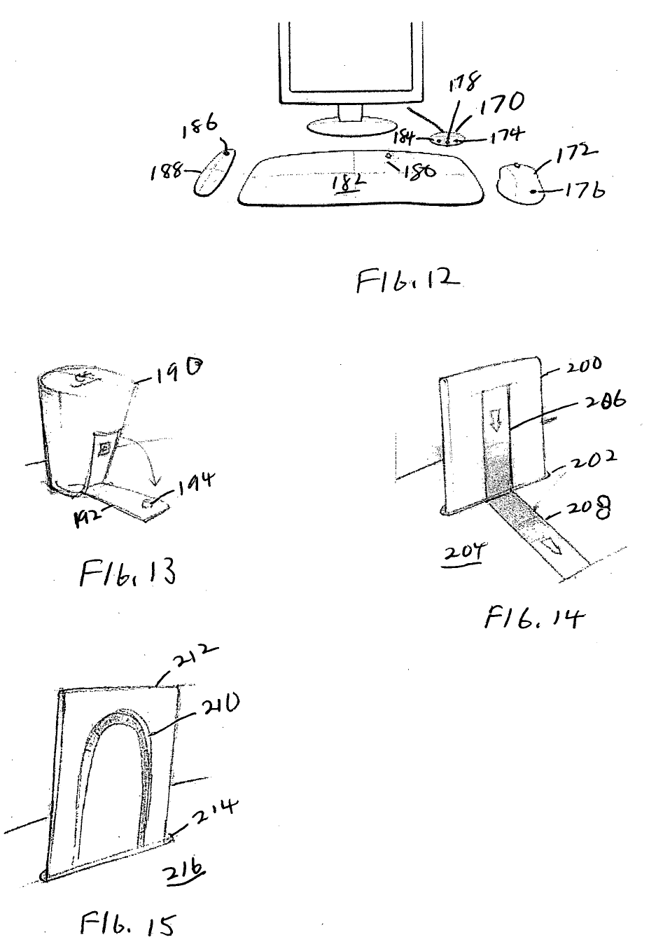

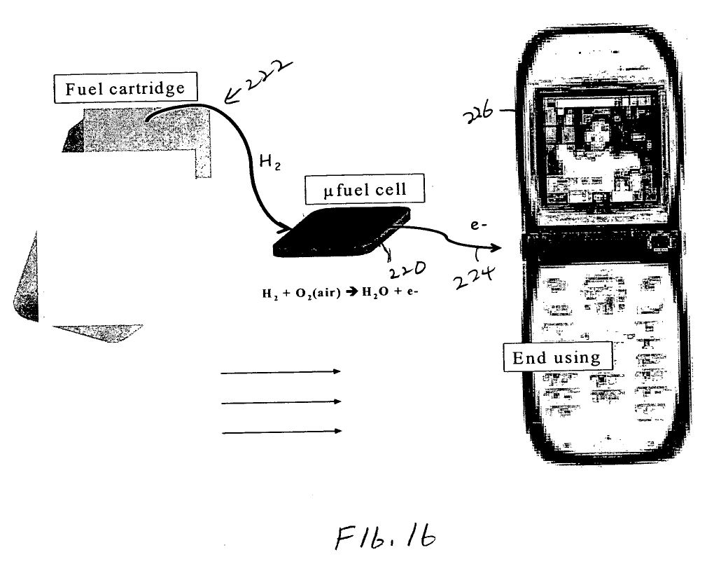

In one embodiment, the charging is done through induction, which requires that the device be positioned correctly over or near the charger, but doesn't require a mechanical connection. A display indicates when the device is properly placed, giving user feedback. Examples of displays are discussed below with respect to FIG. 14. Notification is also provided to show when charge is flowing and when the charging is completed.

FIG. 3 illustrates an embodiment of a charger 50 having a ribbon cable 52 for connecting to a device. The ribbon cable includes an elongated connector 54 which engages a slot in a device such as a mouse 56. Similar connector slots are shown as connectors 58 and 60 in keyboard 62 and remote control 64, respectively. The flexible, ribbon connector is spring loaded and can be pulled out and retract in a manner similar to a tape measure. This eliminates the cord being in the way on the desktop when it is not in use. The connector slots in the devices are located where they can be accessed without turning the device over. In some embodiments, the connectors are in the top case of the device such as shown for the keyboard and remote in FIG. 3.

FIG. 4 illustrates the ribbon cable 52 being pulled back into charger 50. This could be triggered by the charger detecting that charging has completed, with connector 54 including a solenoid to release a connecting mechanism, and a solenoid in charger 50 to activate the spring retrieval mechanism by releasing a brake on the ribbon cable, allowing the spring to pull it in.

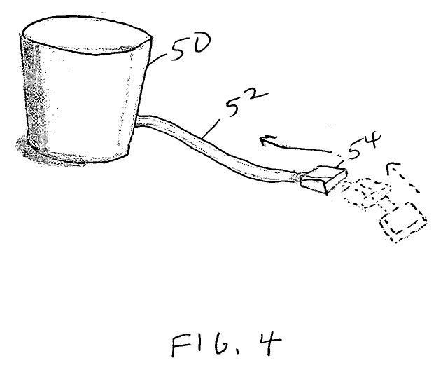

FIG. 5 illustrates a low profile charger 70 having a raised bump 72 for locating the device to be charged over the low profile charger. The charging can be done either by a wireless method, such as induction. Alternately, a wired connection through contacts can be made. In either case, the location of bump 72 to engage a corresponding depression in the device facilitates in locating the device properly on an otherwise low profile flattop charger. Alternately, other locating mechanisms may be used. The weight of the device or a clip can be used to maintain a secure connection.

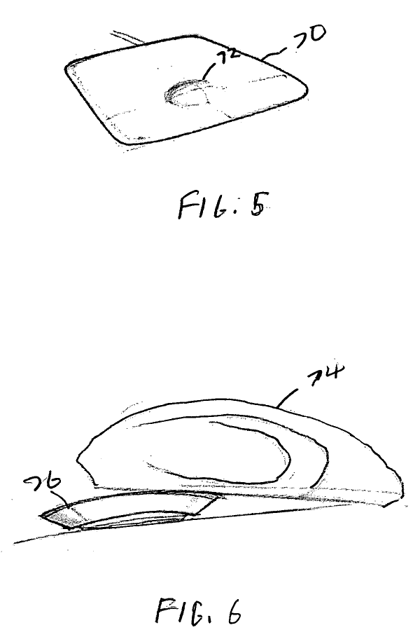

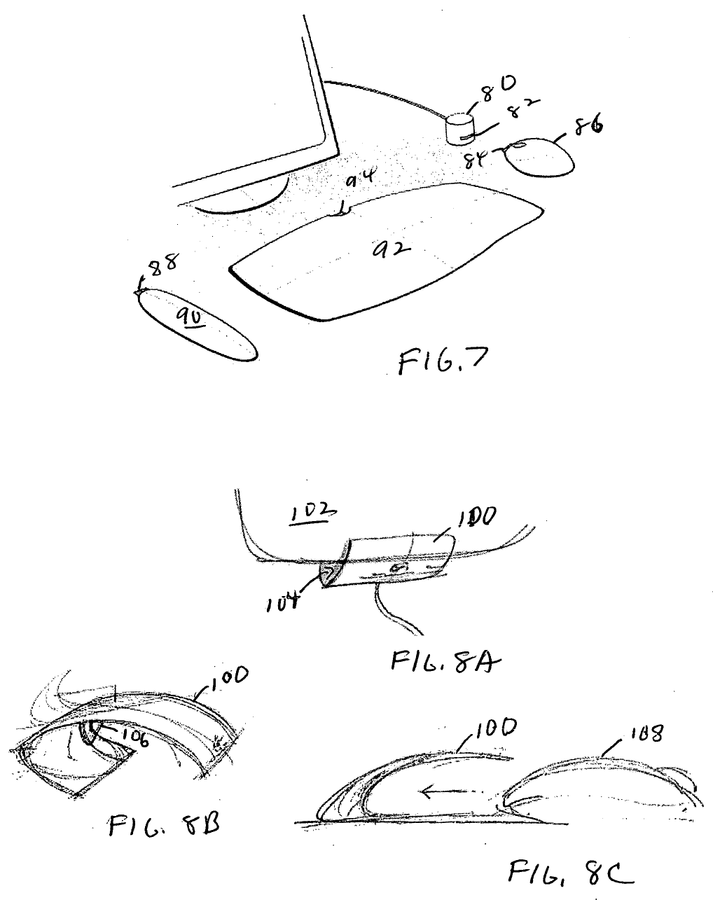

FIG. 6 illustrates a mouse 74 mounted on top of a low profile charger 76.

FIG. 7 shows an alternate embodiment of the invention in which a charger 80 includes a connector slot 82. A tab or blade 84 on a mouse 86 will slide into slot 82 to provide a connection. Similarly, a tab 88 on a remote control 90 can engage slot 82. In both cases, the smaller devices are easily moved to charger 80. For keyboard 92, with its tab 94, charger 80 may be moved to it so that slot 82 engages tab 94 to provide the charging connection. The tab may be partially or totally concealed, such as by being in a concave slot as shown for the keyboard. In one embodiment, the tab or blade connector is spring loaded, and can be extended and retracted with a positive click.

FIG. 8A shows an alternate embodiment in which a charger includes a connector member 100 for connecting to a device 102. Connector member 100 has a concave slot 104 for engaging the device 102.

FIG. 8B is a view from the side of one embodiment of device 100 showing an internal tab 106 for providing the electrical connection to device 102. Member 100 is spring biased so that it can both expand and contract to grasp onto and engage with the side of peripheral 102. The spring biasing allows the charger connector member 100 to expand to engage with different devices, such as expanding to engage a mouse 108 as illustrated in 8C.

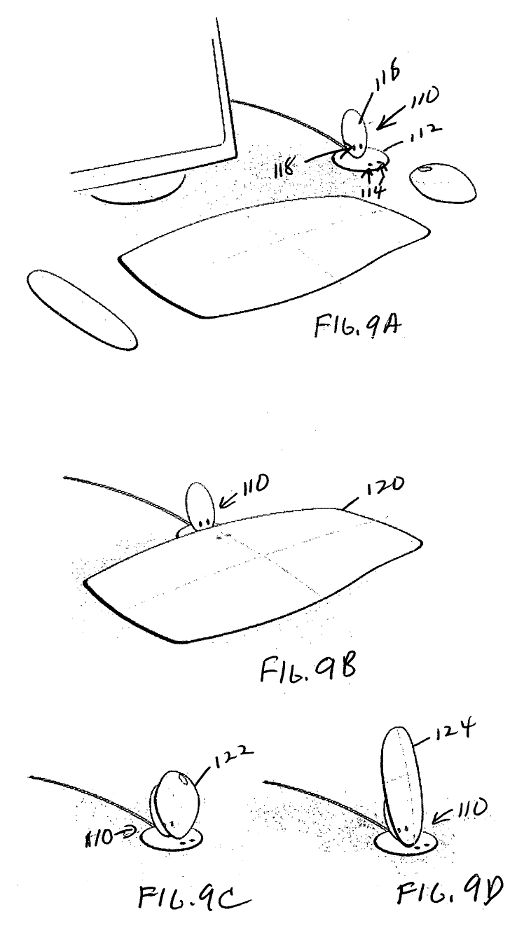

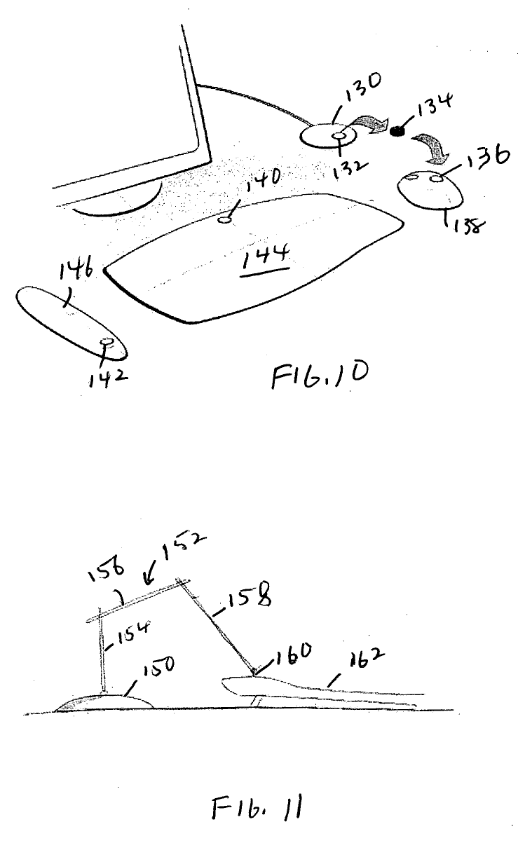

FIGS. 9A-9D illustrate an embodiment of the invention where a charger 110 includes a low profile portion 112 with contacts 114. In addition, a vertical portion 116 contains separate contacts 118. As shown in FIG. 9B, charger 110 can be moved over to a large device such as a keyboard 120, which engages contacts 114. Alternately, smaller devices can be moved to the charger, such as mouse 122 in FIG. 9C and remote control 124 in FIG. 9D. In both cases, the mouse and remote control connect to contacts 118 on the vertical portion 116 of charger 110.

FIG. 10 illustrates an alternate embodiment of the invention in which a charger 130 includes a receptacle 132 for charging a flash capacitor or power cell 134. The cell 134 can then be removed and placed in a receptacle 136 in a mouse 138, wherein it will connect, through contacts, to an internal battery of mouse 138 for rapid charging of the battery. Similar receptacles 140 and 142 are provided in a keyboard 144 and in a remote control 146. The power cell will take hours to charge in the charging base station, but will only take seconds or a few minutes to re-charge an electronic device. The charging station or the cell itself can indicate current power levels and estimate the time remaining until full charge is available. The cell discharge is indicated visually, such as by any of the methods described below with respect to FIG. 14.

FIG. 11 illustrates an embodiment of the invention wherein a charger 150 includes a stiff articulating mechanism 152 including arms 154, 156 and 158. The articulating mechanism 152 carries a cable which connects to a connector 160 in a keyboard 162 to provide charging. This addresses the issue of cable management and instead allows a connector which does not clutter up the desktop and allows easy removal when not in use with the articulating mechanism 152 folding to a more compact shape.

FIG. 12 illustrates an embodiment of a charger 170 which can provide an indication of when the peripheral devices associated with it need charging. This is accomplished by having wireless or wired (USB, etc.) communication between the charger and the devices. The charger either interrogates the devices, or the devices periodically report their charge status. When, for example, a mouse 172 has low charge, a red light 174 will light up on charger 170 indicating that mouse 172 needs charging. The user can associate red light 174 with a mouse because a red light 176 is supplied on the mouse. The red light on the mouse may be constantly on or may be only turned on when light 174 turns on. The lights may be constant or blinking.

Similarly, a yellow light 178 may correspond to a yellow light 180 on a keyboard 182. An orange light 184 may correspond to an orange light 186 on a remote control 188. Alternately, other colors may be used, or lighted icons corresponding to the devices or matching icons on the devices may be used. Additionally, any other matching identification can be provided.

Alternately, the charger can cause a visual alert such as a pop up to appear on the computer screen. For a charger for devices in a home, the visual alert might appear on the T.V., such as for a remote control. A visual alert may be made to appear on the device itself if it has a display. Alternately, a vibration alert could be used.

FIG. 13 is a diagram of an embodiment of a charger 190 which has a connector door 192 which drops open when a device needs charging. Door 192 includes the connector 194 for connecting to the particular device. This provides a visual indication that the device needs to be charged. Charger 190 knows the device needs to be charged by communicating with the device as described above. Also, the charger could automatically mechanically disconnect or recoil when charging is done. This could be done in combination with indicator lights which indicate both when charging is needed and when charging is completed.

FIG. 14 illustrates a charger 200 inserted into a slot connector 202 of a device 204 to be charged. Charger 200 includes a light display 206 which is linear and appears to connect to a separate light display 208 on device 204. During charging, light can start to be displayed on display 206 and run on to display 208 as the device is charged, giving the visual impression of charge moving from the charger to the device.

The visual display can also be used to confirm connection, such as by sending a flash of light from the charger to the device or vice-versa. This would be followed by the steadily advancing of light as the device is charged. Alternately, animated light could be used, or a solid light display could be used, with its color changing as the device is charged. Also, the color of light could indicate the amount of time the device has been charged for. Alternately, a time could be displayed on the display indicating the likely length of time the charge will last, so the user can remove the device before full charging if a full charge is not needed and the user is in a hurry. The time would be calculated using information about the device associated with the charging profile.

In addition, a history of charges could be maintained for each device in a memory in the charger or a connected computer, with the history being used to revise the calculation of how long a charge should last, thus enabling more accurate displays. Also, the charging profile can be modified based on this history information. The history would reveal capacity changes in the battery, and may also indicate when a rechargeable battery has worn out. A display of the maximum time the full charge is likely to last can be provided and updated, giving the user an indication of when the rechargeable battery or the device itself should be replaced.

FIG. 15 is an alternate embodiment showing a curved display 210 on a charger 212 mounted in a slot 214 of a device 216. The curving gives the impression of starting from the internal part of the charger and curving around and down towards the device to be charged, providing an indication of the amount of charge.

FIG. 16 is diagram of an embodiment of the invention using a fuel cell 220 as the charger. The fuel cell can be refilled through fuel cartridges 222. Power from the fuel cell is provided either wirelessly or through a wire 224 to a device such as a cell phone 226. The fuel cell can have associated with it circuitry or memory for storing the particular power profile and charging characteristics of the device. Any number of the methods described above for determining the charging profile can be used. The fuel cell can be used without being itself plugged in, and may, for example, be able to provide four full charges of cell phone 226 on a business trip. As described above, the type of device can be identified to the fuel cell through a number of means, such as the adaptor identifying itself, the charger or the communicating directly with the device either wirelessly, through a USB connection, or by reading an RFID chip in the device to determine its identity.

As will be understood by those of skill in the art, the present invention could be embodied in other specific forms without departing from the essential characteristics thereof. For example, devices other than those mentioned could be charged and provided with the appropriate connectors, displays, etc., such as PDAs, cell phones, laptops, cameras, music and video players, gamepads, joysticks, steering wheels, headphones, etc. Accordingly the foregoing description is intended to be illustrative, but not limiting, of the scope of the invention which is set forth in the following claims.

What is claimed is:

1. A method for configuring a charger for a plurality of devices, comprising:
accessing over a network a database of charging profiles;
selecting at least one charging profile corresponding to a device to be charged; and
downloading said charging profile to said charger.

2. The method of claim 1 wherein said charging profiles are downloaded from said database to a computer, and from said computer over a USB connection to said charger.

3. The method of claim 1 wherein said accessing occurs automatically upon detection of said device by a computer.

4. The method of claim 1 further comprising identifying said device by said charger communicating with said device.

5. The method of claim 4 wherein said communication is over a USB connection.

6. The method of claim 4 wherein said communication is wireless.

7. The method of claim 6 wherein said wireless communication comprising reading an RFID tag in said device.

8. The method of claim 1 wherein said charger operates as a stand alone device once the profiles of desired associated devices have been downloaded.

9. The method of claim 1 further comprising displaying devices for the user to select to charge and an indication of the charging status.

10. A charger comprising:
a communication port for communicating with a computer and at least one of a plurality of devices;
a charging interface for providing charge to said plurality of devices.

11. The charger of claim 8 further comprising:
a memory in said charger for storing charging profiles for said plurality of devices.

12. The charger of claim 10 wherein said charging interface further comprises:
a USB connector for providing power to said plurality of devices.

13. The charger of claim 10 further comprising:
a USB hub; and
a plurality of USB connectors.

14. The charger of claim 10 wherein said charging interface comprises:
a ribbon cable; and
a spring mechanism for extending and retracting said ribbon cable into said charger.

15. The charger of claim 10 wherein said charging interface comprises:
a first low profile connector, said charger being movable to connect said low profile connector to a stationary first device; and
a second connector above said first connector, said second connector supporting and connecting to a second device.

16. The charger of claim 10 wherein said charging interface comprises:
a removable power cell.

17. The charger of claim 10 wherein said communication port comprises:
a first USB port for connecting to said computer; and
a second USB port for connecting to one of said plurality of devices.

18. The charger of claim 10 further comprising:
a light display for providing a light indicator that moves over time toward one of said devices; and
a charge monitoring module configured to send a signal to said device to activate a light indicator on said device when the light indicator on said charger reaches a point proximate said device.

19. The charger of claim 10 further comprising:
a plurality of different visual indicators, each of said visual indictors corresponding to a similar visual indicator on one of said devices.

20. The charger of claim 19 wherein each of said different visual indicators is a different color.

21. The charger of claim 10 further comprising:
a connector compatible with all types of AC plugs worldwide.

22. A charging system comprising:
(a) a charger including
a charge light indicator; and
(b) a device including
a connector for connecting to said charger so that said charge light indicator is immediately adjacent said device;
a charge light indicator positioned on said device adjacent said connector so that light can appear to move from said charge light indicator on said charger to said charge light indicator on said device.
